(19) United States
(12) Patent Application Publication
(10) Pub. No.: US 2016/0173822 A1
(43) Pub. Date: Jun. 16, 2016

(54) METHODS AND SYSTEMS TO FACILITATE A LARGE GATHERING EXPERIENCE

(71) Applicant: Net Power and Light, Inc., San Francisco, CA (US)

(72) Inventors: Tara Lemmey, San Francisco, CA (US); Stanislav Vonog, San Francisco, CA (US); Nikolay Surin, San Francisco, CA (US)

(21) Appl. No.: 15/051,444

(22) Filed: Feb. 23, 2016

Related U.S. Application Data
(63) Continuation of application No. 13/843,972, filed on Mar. 15, 2013.

(51) Int. Cl. H04N 7/15; H04L 12/58

(52) U.S. Cl. CPC H04N 7/15; H04L 51/32; H04L 51/20

(57) ABSTRACT

Methods and systems to provide an emotional experience for people connected via devices in a large gathering of an event through an experience engine system are disclosed. An example the method includes: aggregating contributions from individuals or small groups into an aggregate to participate in an expression of a whole of the large gathering; generating the expression of the whole for broadcast when the aggregate of the contributions satisfy a threshold; facilitating formation of a small group of participants within the large gathering; providing a service to facilitate synchronized intimate interaction within the small group; and generating a version of a gathering presentation configured to selectively focus attention of a large subset of participants of the large gathering on contents related to or from a specific individual contributor or a specific small group of the large gathering.

### CROSS-REFERENCE TO RELATED APPLICATIONS

This application is a Continuation of U.S. patent application Ser. No. 13/843,972, filed Mar. 15, 2013; the contents of which are incorporated herein by reference in their entirety.

### FIELD OF INVENTION

The present teaching relates to a large gathering facilitation system, and in particular to providing one or more interfaces for participants of a large gathering event to feel deeply connected to the event.

### BACKGROUND

People appreciate unique deep experience shared together with other people. With the evolution and revolution of electronic devices, including increase in network speed and processing power, industries have tried to enhance or reconstruct these unique deep experiences by use of the electronic devices. One of the unique deep experiences appreciated by many is the unique deep experience felt at large gatherings for specific events. These could be sports events, parades, debates, celebrations, holidays, competitions, or any number of things that bring people together. However, it has been challenging to reconstruct or enhance the deep experience of large gatherings. For one, even with today's technologies, all of the sensory inputs and potential interaction amongst people are difficult to reconstruct correctly. Current technologies fail to enhance the experience because the technologies do not provide a way for emotional connection with the large gathering.

### DISCLOSURE OF THE INVENTION

Techniques for facilitating an experience with a large gathering of people are disclosed. The techniques include enhancing the experience of the people at a gathering site and emulating the experience of being with a large crowd for a person away from the gathering site. The techniques include at least three components, including: a whole expression service to generate and present an expression of a whole of the large gathering, a group facilitation service to form a small group within the large gathering and to facilitate intimate interactions with in the small group, and an engagement service to facilitate active participation. Modules on devices operated by participants may be coupled to these services via a network. The techniques may be implemented via computing devices with both sensory input and output capabilities. The whole expression service facilitates capturing and aggregating of individual contribution to the expression of the whole from individuals via devices operated by the individuals. The whole expression service can represent the evolution of the expression by generating real-time feedback between the large gathering and individuals. The group facilitation service enables an individual to create intimate groups within the large gathering of people without severing the interactive experience of the individual with the wholeness of the large gathering. The engagement service engages an individual or a small group to active participation with the large gathering by a mechanism that re-focuses the attention of the large gathering to any individual.

Some embodiments have other aspects, elements, features, and steps in addition to or in place of what is described above. These potential additions and alternatives are described throughout the rest of the specification.

### BRIEF DESCRIPTION OF DRAWINGS

These and other objects, features and characteristics of the present invention will become more apparent to those skilled in the art from a study of the following detailed description in conjunction with the appended claims and drawings, all of which form a part of this specification. In the drawings:

FIG. 1 illustrates an example of people using devices to participant in a large gathering.

FIG. 2 illustrates a block diagram of a system environment for a large gathering experience system to facilitate an experience with a large gathering of people.

FIG. 3 illustrates a control flow of a large gathering experience system.

FIG. 4 illustrates a control flow diagram of a producer device.

FIG. 5 illustrates a control flow diagram of an experience engine system.

FIG. 6 illustrates a flow diagram of a method of operating the first participant device of the large gathering experience system of FIG. 3.

FIG. 7 illustrates a flow diagram of a method of operating the experience engine system of FIG. 3.

FIG. 8 illustrates a block diagram of a wireless device.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION OF THE INVENTION

References in this specification to “an embodiment,” “one embodiment,” or the like mean that the particular feature, structure, or characteristic being described is included in at least one embodiment of the present invention. Occurrences of such phrases in this specification do not necessarily all refer to the same embodiment.

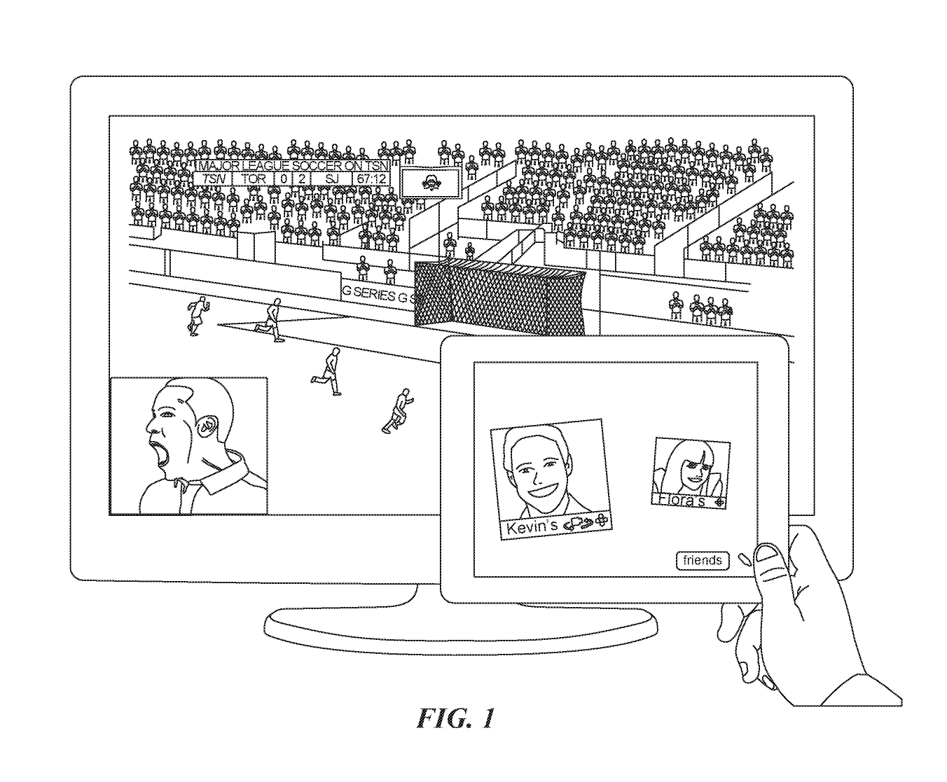

FIG. 1 illustrates an example of people using devices to participant in a large gathering. A large gathering in this disclosure is a gathering of people, such as for an event or other spontaneous reasons, where the number of the people is beyond where a single person can make close contacts with all other participants for the duration of the gathering. It has been discovered that wholeness expression, intimate interactions, and active engagements are the core ingredients in providing deep emotional connections for participants at a large gathering for an event. Absence of any one of these core ingredients would undermine the emotional connection a person has with the large gathering.

Hence, this disclosure contemplates a set of services provided by an experience engine system and modules on one or more participant devices and one or more producer devices that facilitate expressions of the whole, intimate interactions within a small group, and active engagements with the gathering. The modules on the participant devices expand the availability of large gatherings to participants around the world at different gathering sites and even offsite participants. The services provided enhance the experience of onsite participants, and make the experience available to off-site participants. While a device-assisted meeting would normally fail to scale the emotional connection of participants, the whole expression service, the group facilitation service, and the engagement service allow the scaling to happen by reconstructing the core ingredients for providing deep emotional connections at a large gathering.

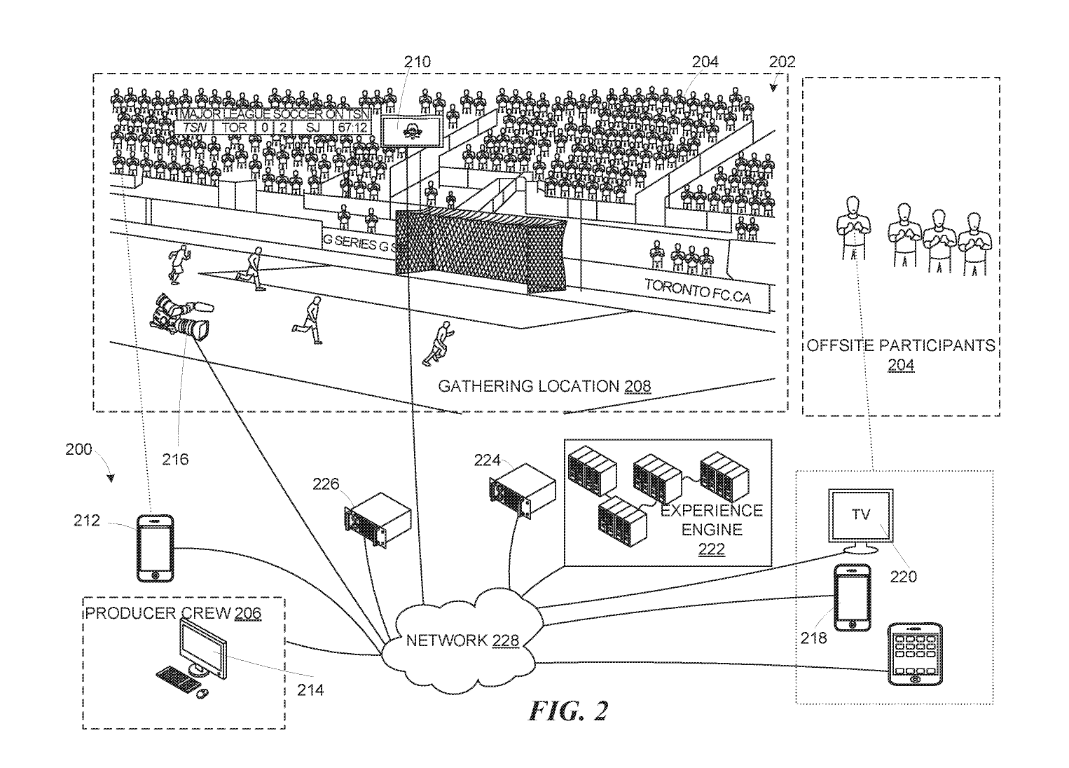

FIG. 2 illustrates a block diagram of a system environment for a large gathering experience system 200 to facilitate an experience with a large gathering 202 of people. Participants 204 of the particular gathering 202 can be distributed across multiple locations. The particular gathering 202 can include a producer crew 206, who are the participants 204 integral to real-time management of the particular gathering 202 and/or constantly drawing attention from the large gathering for the purpose of the particular gathering 202. For example, the particular gathering 202 can be a concert. The producer crew 206 can be the musicians and the producers of the concert. Other examples of the particular gathering 202 with the producer crew 206 include a sports game, a political debate, an election, a parade, a new year's party, or any combination thereof. In other examples of the large gathering, there are no real-time producers and the large gathering can be spontaneous, such as a protest or a flash mob.

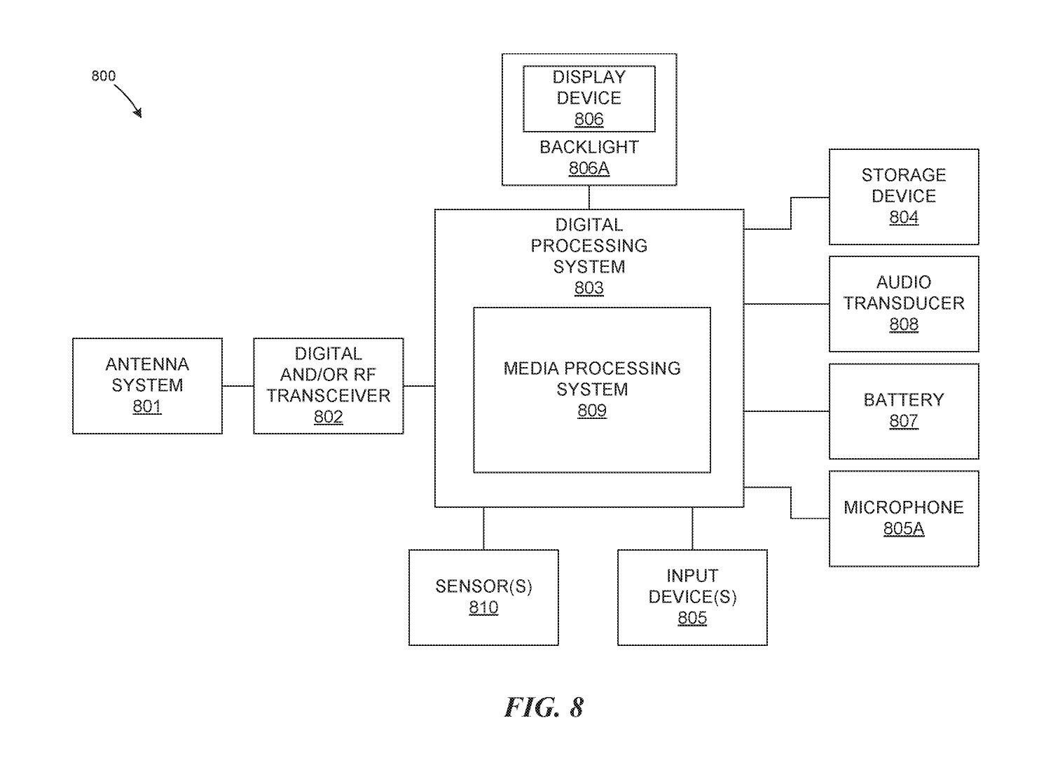

The particular gathering 202 may be hosted at a gathering location 208. In different examples, there can be more than one gathering locations, such as multiple town squares synchronized to celebrate new years. The gathering location 208 can include onsite output devices 210. The onsite output devices 210 are electronic devices that can be controlled to change its output based on real-time configuration. For example, the onsite output devices 210 can include a jumbotron, a speaker, light control panel, or any combination thereof. The participants 204 at the gathering location 208 may operate onsite mobile devices 212, such as the wireless device 800 of FIG. 8. The onsite mobile devices 212 are portable electronic devices operated by the participants 204 who are participating at the particular gathering 202 at the gathering location 208. Producer equipments 214 may also be operated on-site of the gathering location 208. The producer equipments 214 are electronic devices, including computer systems, for facilitating and managing the particular gathering 202. The producer equipments 214 may be operated by the producer crew 206 of the particular gathering 202. For example, the producer equipments 214 can control onsite input devices 216, such as broadcasting a sensory data stream from the onsite input devices 216 through the large gathering experience system 200. The onsite input devices 216 are electronic sensor devices capable of capturing a sensory data stream in real-time. For example, the onsite input devices 216 can be cameras, microphones, thermometer, tactile sensors, pressure sensors, voting devices, or any combination thereof.

The system environment includes the participants 204 who are off-site from the gathering location 208. The participants 204 who are off-site may operate offsite participant devices 218, such as the wireless device 800 of FIG. 8. The offsite participant devices 218 include the same mobile electronic devices as operated by the participants 204 at the gathering location 208 except the devices are operated outside of the gathering location 208. The offsite participant devices 218 can also include computers, game consoles, laptop computers, or other electronic computing device capable of capturing inputs from the participants 204. The participants 204 who are off-site may also be engaging in viewing offsite output devices 220. The offsite output devices 220 are similar to the onsite output devices 210 except they are operated outside of the gathering location 208. For example, the offsite output devices 220 can include television sets, console boxes connected to display devices, set top boxes connected to display devices, speakers, desktop computer with monitor, or any combination thereof. The offsite output devices 220 do not have to be attached to a computer.

The large gathering experience system 200 can includes any combination of the devices described above, including the producer equipments 214, the onsite mobile devices 212, the onsite output devices 210, the offsite participant devices 218, or the offsite output devices 220. The purpose of the large gathering experience system 200 is to facilitate deep emotional connections of the participants 204 of the particular gathering 202. The large gathering experience system 200 assists in making the participants 204 feel that their emotions are scaled with the grandeur and largeness of the gathering such that they are part of the epic happening of the gathering. It is essential that the large gathering experience system 200 can facilitate both onsite and offsite participants to perceive expressions of the gathering as a whole, to have intimate interactions within small groups within the whole, and to feel the need to actively engage with the gathering.

Part of the intelligence of the large gathering experience system 200 may be provided by services implemented by an experience engine system 222 hosted on one or more computer systems and application layers on one or more producer devices or one or more participant devices. The large gathering experience system 200 may further include experience facilitation applications executable on the producer equipments 214, the offsite participant devices 218, the onsite mobile devices 212, the onsite output devices 210, the offsite output devices 220, or any combination thereof. The experience facilitation applications operate the devices to communicate with the experience engine system 222 to facilitate an interface with each of the participants 204, where the interface provides the necessary components to accomplish the purpose of the large gathering experience system 200 for deep emotional connections between the participants and the large gathering of the particular gathering 202.

The large gathering experience system 200 may further include a content delivery system 224 and a third-party service system 226. The content delivery system 224 is configured to deliver digital multimedia content to the onsite output devices 210, the onsite mobile devices 212, the offsite participant devices 218, the offsite output devices 220, the producer equipments 214, or any combination thereof. For example, the content delivery system 224 can deliver playback videos of the particular gathering 202. The third-party service system 226 is configured to provide services to the participants 204 via the participant devices. For example, the third-party service system 226 can provide relevant advertisement, live commentary, or moderation of active participation of the participants 204.

Inputs from the participants 204 can be captured via a participant terminal device including the onsite mobile devices 212 and the offsite participant devices 218. Inputs from the participants 204 can be multimedia experience contents. Multimedia experience content is provided to other participants as part of the large gathering experience. The multimedia experience content inputs include live feeds, photographs or audio clips captured for the particular gathering 202, text or audio messages, drawings, or any combination thereof. The multimedia experience content can be captured as inputs from the offsite participant devices 218 and the onsite mobile devices 212. The multimedia experience contents are important to interact with other participants and to contribute actively to the expressions of the large gathering.

Inputs can also be passive signals recognized by the large gathering experience system 200 as pertaining to the emotional state or expression of the participants 204 of the live gathering. For example, passive signals can include loudness of a participant as captured from a microphone, biosensor signals, or patterns recognized from the sensors of the participant devices. For example, the patterns can include eye tracking patterns, audio patterns, movement patterns, color patterns, brightness patterns, biosensor patterns, hand or body gesture patterns, or any combination thereof. As a specific example, the participant devices can capture video feeds, and provide the video feeds for pattern analysis either by the experience engine system 222 or on the participant devices. The pattern analysis can include color distribution of the live feeds, such as if the live feeds of the participants 204 all include a lot of the orange color because everyone is waving an orange flag for the particular gathering 202). The passive signals are important for analysis of whether a participant is actively participating and contributing to the expressions of the whole of the large gathering.

The systems, devices, and equipments described above can communicate with each other via a network 228. The network 228 is a system for communication. The network 228 can encompass a variety of mediums of communication, such as wired communication for one part and wireless communication for another part. The network 228 can be part of the Internet. The terrestrial television programming can include a transmitter station 207 on one end of the network 228 and an antenna receiver at another end of the network 228.

For example, the network 228 can include an Ethernet or other wire-based network or a wireless NIC (WNIC) or wireless adapter for communicating with a wireless network, such as a WI-FI network, a cellular network, a Bluetooth network, or any combination thereof. The network 228 can include any suitable network for any suitable communication interface. As an example and not by way of limitation, the network 228 can include an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As another example, the network 228 can be a wireless PAN (WPAN) (such as, for example, a BLUETOOTH WPAN), a WI-FI network, a WI-MAX network, a 3G or 4G network, a cellular telephone network (such as, for example, a Global System for Mobile Communications (GSM) network).

In one embodiment, the network 228 can use standard communications technologies and/or protocols. Thus, the network 228 can include links using technologies such as Ethernet, 802.21, worldwide interoperability for microwave access (WiMAX), 3G, 4G, CDMA, digital subscriber line (DSL), etc.

In some different examples, one-way communication networks can be used to deliver content to the offsite output devices 220, such as satellite, terrestrial television programming, or other methods. For example, the participant devices including a television or a set top box can receive video content via the network 228 including the DVB-T, DVB-H and ATSC-M/H transmissions via the antenna receiver.

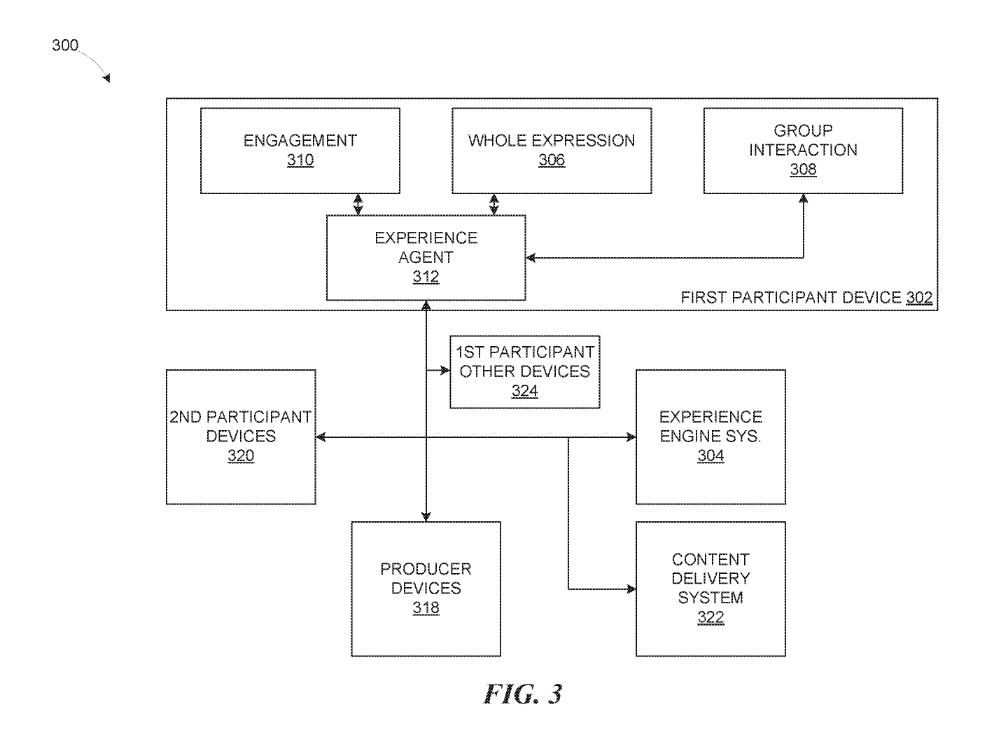

FIG. 3 further describes mechanisms and tools in the large gathering experience system 200 to facilitate a large gathering experience described herein based on the inputs from the participants 204 and the producer crew 206, and from live happenings at the gathering location 208. The facilitation of the large gathering experience includes presenting an expression of the whole of the large gathering (i.e., the navigation, movement, activity, or communication of the entire crowd), soliciting individual contribution to the expression of the whole, creation of small intimate groups with the whole, providing an experience sharing interface for intimate in-group interactions and synchronized shared experiences through the participant devices, and providing an interactive interface for a small group or an individual contributor to engage with the particular gathering 202 of the large gathering.

FIG. 3 illustrates a control flow of a large gathering experience system 300. The large gathering experience system 300 may be the large gathering experience system 200 of FIG. 2. The large gathering experience system 300 includes a first participant device 302, such as the wireless device 800 of FIG. 8. The first participant device 302 is an electronic device, coupled to an experience engine system 304, operated by one of the participants 204 of FIG. 2. For example, the experience engine system 304 may be the experience engine system 222 of FIG. 2. The first participant device 302 can be one of the offsite participant devices 218, the onsite mobile devices 212, the onsite output devices 210 or the offsite output devices 220.

One or more methods to facilitate a large gathering experience may be implemented by modules described below. The modules may be implemented as hardware components, software modules, or any combination thereof. For example, the modules described can be software modules implemented as instructions on a non-transitory memory capable of being executed by a processor or a controller on a machine.

Each of the modules may operate individually and independently of other modules. Some or all of the modules may be executed on the same host device or on separate devices available for operation by the same participant. The separate devices can be multiple coordinated devices each with an agent application to coordinate its operation as one. Some or all of the modules may be combined as one module. A single module may also be divided into sub-modules, each sub-module performing separate method step or method steps of the single module. The modules can share access to a memory space. One module may access data accessed by or transformed by another module. The modules may be considered “coupled” to one another if they share a physical connection or a virtual connection, directly or indirectly, allowing data accessed or modified from one module to be accessed in another module.

The large gathering experience system 300 may include additional, fewer, or different modules for various applications. Components such as cellular network interfaces, security functions, operating system(s), and the like are not shown so as to not obscure the details of the system.

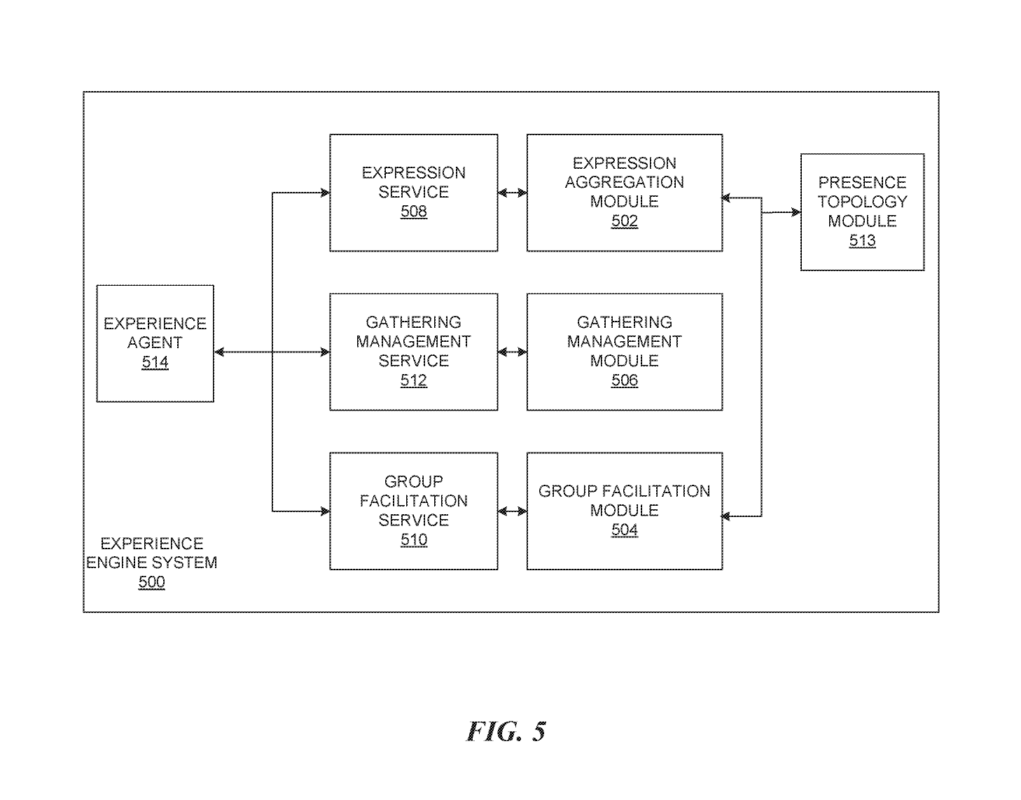

The first participant device 302 includes a whole expression module 306, an group interaction module 308, and an engagement module 320. Each of these modules interacts with the experience engine system 304 as described in FIG. 5. Through an experience agent module 312, the whole expression module 306, the group interaction module 308 and the engagement module 320 may communicate with their counter parts on the experience engine system 304. The experience agent module 312 may be configured to access an application programming interface (API) on an external system, which is an interface that defines available services, and enables different agents to communicate with one another and request services. The experience agent module 324 enables the external devices to send or receive messages and requests to and from the first participant device 302, such as the messages and requests to and from the whole expression module 306, the group interaction module 308, the engagement module 320, operating system of the first participant device 302, camera and other sensors on the first participant device 302, audio and display of the first participant device 302, GPS and other component services of the first participant device 302, or any combination thereof.

The experience agent module 312 can enable encoding of many types of sensory-related data streams for operation, such as transmission and storage, and decoding sensory-related data streams for operation, such as playback and editing. The sensory-related data streams include graphics, video, audio, sensor data, gesture data, language data via audio, signing/gesturing, or text, emotional data, brain wave and muscle movement data, other perceivable content from or for a person, or any combination thereof.

The whole expression module 306 provides a toolset on the first participant device 302 to encourage individual contribution to participate in an expression of a whole of a large gathering. The whole expression module 306 includes an interface to receive explicit or implicit indications of contribution to the expression of the whole. The whole expression module 306 includes an interface to present the expression in the form of composite layers of multimedia.

For example the whole expression module 306 can present an applause expression as expressed by people of the large gathering. U.S. application Ser. No. 13/528,123 filed on Jun. 20, 2012, titled “METHOD AND SYSTEM FOR PROVIDING GATHERING EXPERIENCE” and U.S. application Ser. No. 13/528,210 filed on Jun. 20, 2012, titled “METHOD AND SYSTEM FOR PROVIDING GATHERING EXPERIENCE”, both incorporated herein by reference, provide specific examples of how these expressions are generated and presented. Other examples include a wave expression illustrated by a video or an animation of people raising their hands in waves synchronized with audio of people cheering in waves.

The whole expression module 306 can present not only an expression of the whole but also where a participant is in relation to other individuals and others small groups in the large gathering. In this way, the whole expression module 306 presents a presence topology giving people some sense of where they are in relation to the whole. The presence topology facilitates an individual participant to move between small groups or within the space which the whole occupies in a meaningful way. For example, to participate in a stadium wave, a participant may need to understand which sector the participant is in and see the wave going through the sectors before the wave reaches the participant and the participant's small group. Once the wave reaches the participant, the participant can then cheer. In this example, the presence topology aids the participant in contributing to the expression of the whole.

The group interaction module 308 provides a toolset on the first participant device 302 to facilitate formation of a small group within the large gathering. The group interaction module 308 further provides an interface for intimate interactions amongst members of the small group, such as by opening up different channels and/or modes of communication amongst the members. The interface for example can be presented on the first participant device 302 showing live streams of members of the small group. The live streams can be synchronized in a way that presentations on the devices of the members reconstruct the same experience, including viewing a presentation of the large gathering on a video stream that is synchronized across devices of the small group.

The interface can support a “group of one”, a group of only a single participant. For example a person can go to a concert alone to be by himself for a while. However, the interface provided via the first participant device 302 enables the person to talk to people next to him and become part of another group, if the person chooses to do so. The interface enables a “group of one” to invite other people to join the small group, to merge with another small group, to engage as a “group of one” with a nearby person, or just opening himself up for the possibility to be joined by others. Unlike being solo where one is stuck being by oneself the whole time, the “group of one” means that everybody has the ability to be alone or to be joined.

The engagement module 320 provides a toolset on the first participant device 302 to encourage active engagement and participation from a person operating the first participant device 302 by generating a gathering presentation on an interface of the first participant device 302. Versions of the gathering presentation may be produced, curated, and presented on all or a large subset of the participant devices connected to the large gathering experience system 200. A large subset is sufficiently numerous enough to be qualified as a large gathering itself. The gathering presentation may be a live multimedia channel on the interface of the first participant device 302. The engagement module 320 may solicit active engagement by providing the possibility that the focus of other participants may be selectively tuned to the person operating the first participant device 302. This anticipation and possibility of recognized contribution encourages the person to actively participate, such as raising his/her hand to be called upon, waving or performing in front of camera that may pan towards him/her, uploading photographs to be curated, waiting on a producer queue (i.e., virtual waiting room) to be questioned, answering a question presented on the gathering presentation, or any combination thereof.

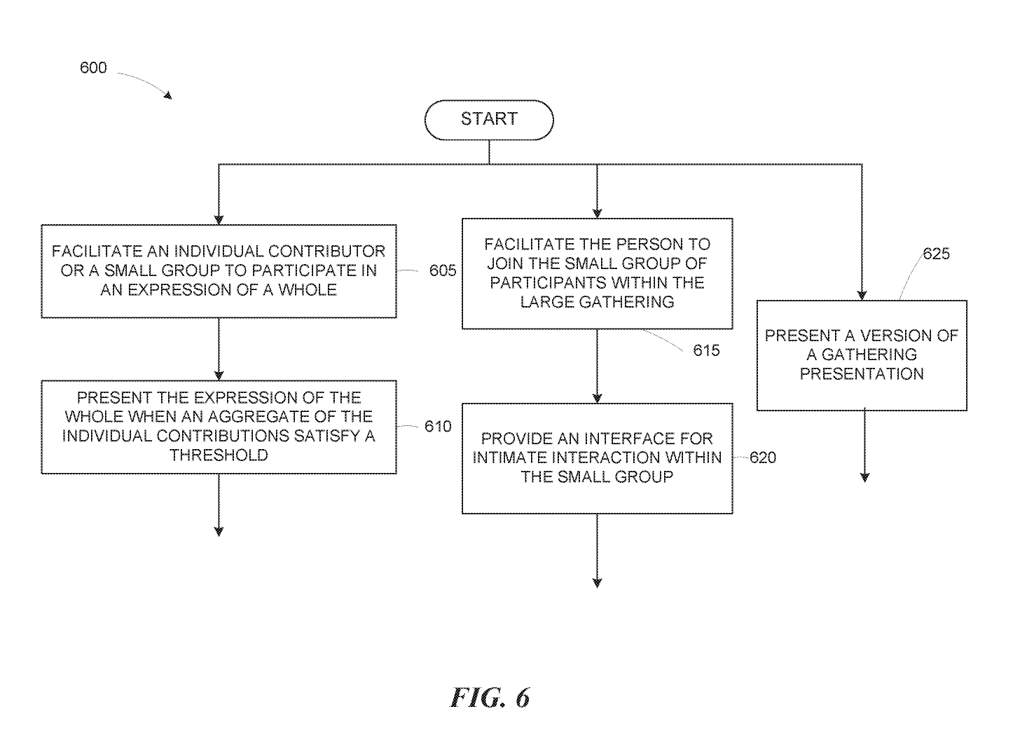

It has been discovered wholeness expression, intimate interactions, and active engagements are the core ingredients in providing deep emotional connections for participants at a large gathering for an event. Absence of any one of these core ingredients would undermine the emotional connection a person has with the large gathering for the event. The whole expression module 306, the group interaction module 308, and the engagement module 320 utilize electronic devices to expand the availability of large gatherings to participants around the world. While a device-assisted meeting would normally fail to scale the emotional connection of participants, the whole expression module 306, the group interaction module 308, and the engagement module 320 allow the scaling to happen by reconstructing the core ingredients for providing deep emotional connections at a large gathering. Further discussion of the operation of the whole expression module 306, the group interaction module 308, and the engagement module 320 are described below in FIG. 6.

The large gathering experience system 300 may also include producer devices 318, such as the producer equipment 214, second participant devices 320, a content delivery system 322, such as the content delivery system 224 of FIG. 2, one or more other first participant devices 324, or any combination thereof. The producer devices 318 enable one or more producer crews to facilitate the large gathering experience. The producer crews may be assigned based on the gathering locations. Each of the producer crews may operate one or more of the producer devices 318, such as a multiple coordinated set of producer devices acting as a single toolset for the producer crew. The one or more other first participant devices 324 can be coordinated with the first participant device 302 to produce a large gathering experience for the first participant.

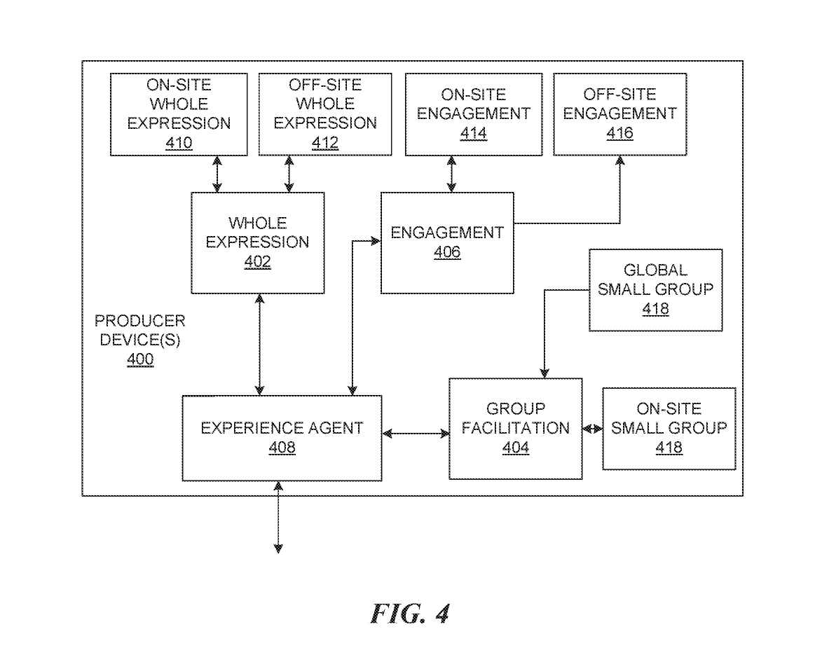

FIG. 4 illustrates a control flow diagram of one or more producer devices 400, such as the producer devices 318 of FIG. 3. One or more methods to enable a producer crew to facilitate a large gathering experience may be implemented by modules described below. The modules can be implemented by a single producer device 400, or multiple coordinated producer devices, such as three tablet devices and a smart phone. The modules may be implemented as hardware components, software modules, or any combination thereof. For example, the modules described can be software modules implemented as instructions on a non-transitory memory capable of being executed by a processor or a controller on a machine.

Each of the modules may operate individually and independently of other modules. Some or all of the modules may be executed on the same host device or on separate devices available for operation by the same participant. The separate devices can be multiple coordinated devices each with an agent application to coordinate its operation as one. Some or all of the modules may be combined as one module. A single module may also be divided into sub-modules, each sub-module performing separate method step or method steps of the single module. The modules can share access to a memory space. One module may access data accessed by or transformed by another module. The modules may be considered “coupled” to one another if they share a physical connection or a virtual connection, directly or indirectly, allowing data accessed or modified from one module to be accessed in another module.

The producer devices 400 may include additional, fewer, or different modules for various applications. Components such as cellular network interfaces, security functions, operating system(s), and the like are not shown so as to not obscure the details of the system. For the purpose of discussion, the example of a single producer device 400 is discussed below, although it is understood that the producer device modules can be implemented on multiple coordinated devices.

The producer device 400 includes a whole expression producer module 402, an group facilitation producer module 404, an engagement producer module 406. Each of the producer modules provides a collection of tools to facilitate the large gathering experience. Through an experience agent module 408, the producer modules may communicate with the experience engine system 304 or other devices of the large gathering experience system 300. The experience agent module 408 may be implemented in the same manner as the experience agent module 312. The experience agent module 408 can send or receive messages or requests to and from external devices, such as the services provided by the experience engine system 304 or sensory data streams from the onsite input devices 216 of FIG. 2. The experience agent module 408 enables the encoding and the decoding of sensory-related data streams in the same manner as the experience agent module 312.

The producer modules can each have two categories of tools provided for the producer crew: onsite tools and offsite tools. For example, the whole expression producer module 402 may include an on-site whole expression module 410 and an off-site whole expression module 412. The group facilitation producer module 404 may include an on-site small group module 418 and a global small group module 420. The engagement producer module 406 may include an on-site engagement module 414 and an off-site engagement module for 416.

The on-site whole expression module 410 provides tools for the producer crew of the large gathering to initiate or orchestrate expressions of the whole at the gathering location(s). The offsite engagement module 412 allows the producer crew to initiate or orchestrate expressions of the whole outside of the gathering location(s).

The on-site small group module 418 provides one or more tools for the producer crew to create, assign, or facilitate a small group of participants at the large gathering location. For example, the producer crew, through the on-site small group module 418, may assign small-group assignments based on locations of specific participants, where the locations of the specific participants are determined via the participant devices or determined by ticket seat at the gathering location. The on-site small group module 418 may enable the producer crew to assign small groups based on other heuristics provided by the producer crew.

The global small group module 420 provides one or more tools for the producer crew to create, assign, or facilitate a small group of participants of the large gathering regardless of whether the participants are on-site or off-site. The global small group module 420 can allow the producer crew to customize each small group, including giving each small group a name or modifying the experience presented on the devices of small groups' members.

The onsite engagement module 414 provides one or more tools for the producer crew to encourage active participation at the gathering location 208. The onsite engagement module 414 allows the producer to manage multiple versions of a gathering presentation for all or a large subset of participants of the large gathering, including curation of uploaded photographs and live feeds from the onsite input devices 216 and from commentators. The onsite engagement module 402 may further provide an interface for the producer to interact with individual participants and small groups at the gathering location(s).

The offsite engagement module 416 provides one or more tools for the producer crew to encourage active participation for offsite participants. The offsite engagement module 416 provides one or more tools for the producer crew to manage and engage with offsite individual participants and small groups. The offsite engagement module 416 may also allow for curation of live feeds, comments, and uploads from offsite participants.

Both the on-site engagement module 414 and the offsite engagement module 416 enable the producer crew to curate contents related to or from specific participants or specific small groups. For example, the contents related to the specific small groups may include photographs or live video streams of the small group members. For another example, the contents from the specific small groups may include photographs or audio clips or text submitted from the members of the specific small groups. Prior to curation, the specific participants or the specific small groups can place themselves on curation queues of the producer crew.

FIG. 5 illustrates a control flow diagram of an experience engine system 500, such as the experience engine system 304 of FIG. 3. The experience engine system 500 is a computer system implemented by one or more host servers. One or more methods to facilitate a large gathering experience may be implemented by modules described below. The modules can be implemented by a host server, multiple server system, or cloud computing clusters. The modules may be implemented as hardware components, software modules, or any combination thereof. For example, the modules described can be software modules implemented as instructions on a non-transitory memory capable of being executed by a processor or a controller on a machine.

Each of the modules may operate individually and independently of other modules. Some or all of the modules may be executed on the same host device or on separate devices. Some or all of the modules may be combined as one module. A single module may also be divided into sub-modules, each sub-module performing separate method step or method steps of the single module. The modules can share access to a memory space. One module may access data accessed by or transformed by another module. The modules may be considered “coupled” to one another if they share a physical connection or a virtual connection, directly or indirectly, allowing data accessed or modified from one module to be accessed in another module.

The experience engine system 500 may include additional, fewer, or different modules for various applications. Components such as network interfaces, security functions, operating system(s), and the like are not shown so as to not obscure the details of the system.

The experience engine system 500 includes an expression aggregation module 502, a group facilitation module 504, and a gathering management module 506. The expression aggregation module 502 provides an expression aggregation service 508. The group facilitation module 504 provides a group facilitation service 510. The gathering management module 506 provides a gathering management service 512. Through an experience agent module 514, the expression aggregation service 508, the group facilitation service 510 and the gathering management module 512 may communicate with their counter parts on participant devices, such as the first participant device 302 of FIG. 3. Particularly, the expression aggregation service 508 may be coupled to the whole expression module 306 of FIG. 3; the group facilitation service 510 may be coupled to the group interaction module 308 of FIG. 3; and the gathering management service 512 may be coupled to the engagement module 320 of FIG. 3. The experience agent module 514 may be implemented in the same manner as the experience agent module 312. The experience agent module 514 provides access to via APIs of the expression aggregation service 508, the group facilitation service 510, and the gathering management service 512. The experience agent module 514 enables the external devices to access the application services provided on the experience engine system 500. The experience agent module 514 enables the encoding and the decoding of sensory-related data streams in the same manner as the experience agent module 312.

The expression aggregation service 508 determines whether an expression of the whole has occurred, generates the expression of the whole, and delivers a message to trigger the presentation of the expression to devices connected to the experience engine system 500 for the large gathering. Determination of the expression may include detecting a pattern from sensory-related data streams from the devices connected to the experience engine system 500 that indicates an aggregation of individual contributions to the expression. Determination may also include counting the number of explicit indications of contribution to the expression of the whole as sent from the whole expression module 306 of individual devices. Generation of the expression includes creation of an animation, a visual, an audio, or any synchronously coupled combination thereof.

The expression aggregation service 508 also manages the expression of the whole with respect to a presence topology. The experience engine system 500 may include a presence topology module 515 to generate the presence topology. The presence topology illustrates where a participant is in relation to other individuals and others small groups in the large gathering. The presence topology represents the proximity amongst participants and small groups. The presence topology can be presented in any number of ways including mapping, panning across live streams of participants and small groups, panning across icons and avatars, sonic methods such as swelling up of audio effects, illustration of one or more collages, illustration of one or more queues, other visual effects or special effects, or any combination thereof.

The expression aggregation service 508, coupled to the presence topology module 515 through the expression module 502, can generate the expression of the whole in reference to the presence topology. For example, the expression aggregation service 508 can generate the expression of the whole by panning over the presence topology, showing that the expression is underway from a cluster of individual and small group presence to another cluster of individual and small group presence. Other ways of generating the expression of the whole includes coupling the expression with a map, sonic methods such as audio effect swelling up, collage illustrations, queue illustrations, other visual effects or special effects, or any combination thereof.

The group facilitation service 510 facilitates formation of a small group of participants within the large gathering. The group facilitation service 510 may enable different channels of communication to open up amongst members of the small group for intimate interaction. The group facilitation service 510 can assist an individual to move from one small group to another via the presence topology. The group facilitation service 510 can be coupled to the presence topology 515 through the group facilitation module 504. For example, group facilitation service 510 can illustrate nearby small groups over the presence topology in order for an individual participant to easily participate with a nearby small group.

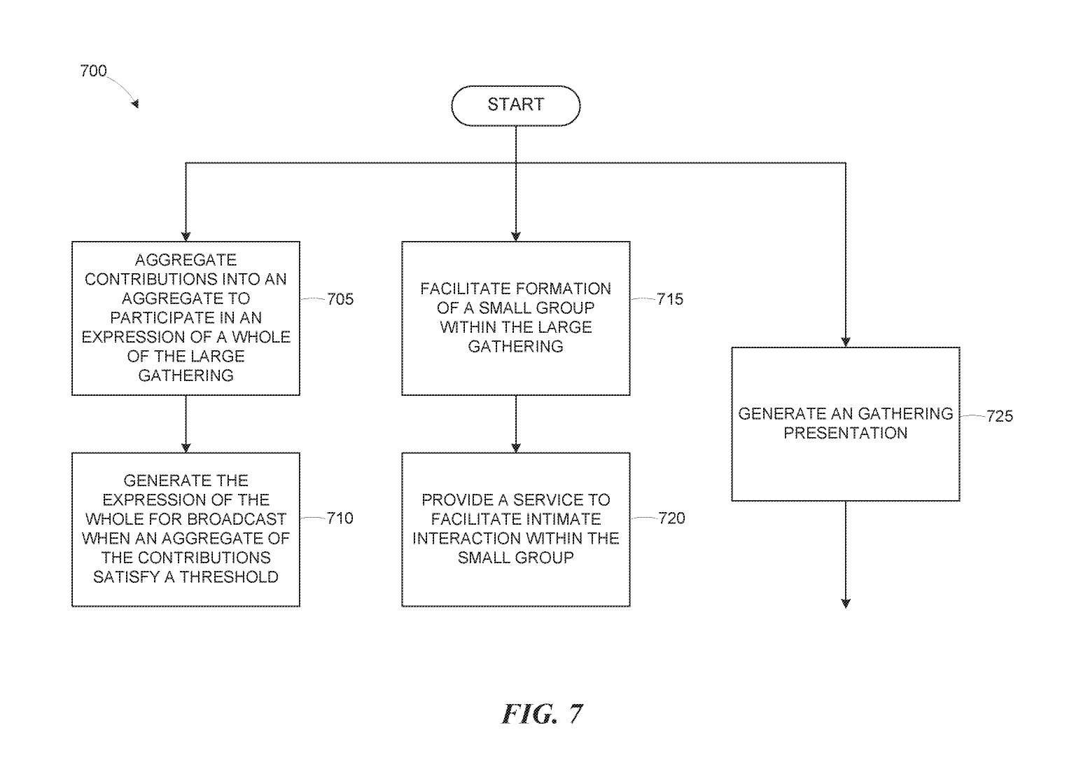

The gathering management service 512 generates a gathering presentation to encourage active participation from participants of the large gathering. The gathering presentation may be curated and managed through the producer crew through the producer devices 318. Versions of the gathering presentation are useful in shifting and focusing the attention of participants of the large gathering. The versions of the gathering presentation may differ slightly based on the type of participant and the type of participant device. In some examples, there can be multiple gathering presentations for different gathering locations and different regions of participants. The gathering presentation may selectively pan the focus of the gathering presentation to feature contents related to or from specific small groups or specific individual contributors of the large gathering. Selection of the featured specific individual or small group can be random, based on producer crew curation, based on response to a solicitation, based on a queue, based on a systematic pattern, based on votes of the participants, based on expressions of the participants, or any combination thereof. Prior to focusing on a specific individual contributor or a specific small group, the producer crew may require that the specific individual contributor or the specific small group to get on a waiting queue. Because of the possibility of recognition by the gathering presentation broadcasted to all participants, participants feel encouraged to actively participate. Further discussion of the operation of the expression aggregation module 502, the group facilitation module 504, and the gathering management module 506 are described below in FIG. 7.

FIG. 6 illustrates a flow diagram of a method 600 of operating the first participant device 302 of the large gathering experience system 300 of FIG. 3. The method 600 provides an emotional experience through a device for a person to participate in a large gathering of an event. The method 600 includes facilitating an individual contributor or a small group to participate in an expression of a whole of the large gathering at a step 605. The step 605 may be performed by executing the whole expression module 306 of FIG. 3. The expression of the whole may be initiated by an individual or small group representative such as the person operating the first participant device 302, or be initiated by a producer, such as one of the producer crew 206 of FIG. 2. The whole expression module 306, when executed, may further present the expression of the whole on the first participant device 302 when an aggregate of individual contributions satisfy a threshold in a step 620. In some implementations, the experience engine system 304 of FIG. 3 may transmit a trigger message indicating the aggregate satisfied the threshold to the first participant device 302 to present the expression of the whole on the first participant device 302.

The expression of the whole may be in the form an audio synchronously played with a display of a visual, such as a wave of orange flags together with a cheer or a napkin wave at a masquerade. The expression of the whole may also be in the form of a live feed from a gathering location of the event, where the live feed is selected to focus on people participating in the expression of the whole at the gathering location (e.g., people at a sports stadium doing the wave). The expression of the whole may scale as more of the individual contributions are aggregated at the experience engine system 304 without actual statistic of people participating in the expression of the whole (e.g., without a number being displayed of the portion or absolute number of people cheering when a cheer expression is delivered). The expression of the whole may include a presentation of regions of people participating in the expression of the whole, such that people participating in one place (e.g., country) will know he/she is part of the whole of people in other places (e.g., other countries).

The method 600 further includes facilitating the person operating the first participant device 302 to join a small group of participants within the large gathering in a step 615. The person may form the small group by his/her own choosing or receive a suggestion to join a small group via the first participant device 302, and confirm the suggestion via the first participant device 302. The suggestion may be made through the producer intimate group module 404. The suggestion may also be made automatically via the group facilitation service 512, such as based on a participant's location. The step 615 may be performed by executing the group interaction module 308 of FIG. 3. Once the small group is created, the group interaction module 308 may provide an interface for synchronized intimate interactions within the small group at a step 620. The interface may open up one or more new communication channels to communicate and interact with members of the small group. The interface also allows a member of the small group to act on behalf of the small group. For example, a group expression may be broadcasted to the producer crew 206. For another example, a group purchase or a group booking on behalf of the small group may be made via the interface. Optionally, the small group interface, however, may or may not be overtaken by the expression of the whole when the expression is presented on the first participant device 302.

The method 600 yet further includes present a version of a gathering presentation through the first participant device 302, the gathering presentation featuring content related to or from a specific individual contributor or a specific small group of the large gathering in a step 625. The step 625 may be performed by executing the engagement module 320 of FIG. 3. The gathering presentation can be a live broadcast to all or a large subset of participants of the large gathering. The version of the gathering presentation may be received from a service of the experience engine system 304 and produced through at least one of the producer devices 318. The gathering presentation can include multiple versions for different categories of participants, participant devices, and location or regions. The gathering presentation may be curated by the producer crew 206. The gathering presentation may selectively tune, via a producer crew, systematically, or randomly, to the inputs from individual contributors or small groups of the large gathering, including inputs from the onsite input devices 216, the onsite mobile devices 212, the offsite participant devices 218, or any combination thereof.

FIG. 7 illustrates a flow diagram of a method 700 of operating the experience engine system 304 of FIG. 3. The method 700 provides an emotional experience for people connected via devices in a large gathering of an event through the experience engine system 304. The method 700 includes aggregating individual contributions from individuals into an aggregate to participate in an expression of a whole of the large gathering in a step 705. The step 705 may be performed by executing the expression aggregation module 502 of FIG. 5. The expressions of the whole may be activity specific (e.g., a SF Giants chant at a Giant's game). Different versions of the expression of the whole may be generated. For example, different visuals for multiple displays may be generated, the multiple displays including the onsite output devices 210 of FIG. 2 and the offsite output devices 220. The expression aggregation module 502 may provide an expression interface to devices, such as the first participant device 302 and the producer devices 318, connected to the experience engine system 304 to define, initiate, or orchestrate the expression of the whole.

The expression aggregation module 502, when executed, further generates the expression of the whole for broadcast when the aggregate of the individual contributions satisfy a threshold in a step 710. Aggregating the individual contribution may include aggregation of implicit contribution and explicit contribution. Explicit contribution may include the indications of individual contributions received through a device connected to the experience engine system 304. Explicit contributions may also include an approximation of total contributions received from the producer devices 318 of FIG. 3. Implicit contribution may include aggregation of contributions by detecting a pattern based on at least a sensor data stream from one of the onsite input devices 216 of FIG. 2. This may include detecting loudness of cheers from microphones, movement of people at the gathering location 208, colors captured by cameras, or any combination thereof.

The method 700 further includes facilitating formation of a small group of participants within the large gathering in a step 715. The step 715 may be performed by executing the group facilitation module 504. The small group may be formed by an invitation-acceptance methodology amongst members of the small group. The producer crew 206 through the producer devices 318 may recommend formation of small groups. The group facilitation module 504 may also recommend small groups based on geographical locations of members of the small group. Once the small group is formed, the group facilitation module 504 provides a service to facilitate intimate interaction within the small group in a step 720.

The method 700 yet further includes the gathering management module 506 generating a gathering presentation in a step 725. The gathering management module 506 may selectively change the gathering presentation to include contents related to or from individual contributors or small groups of the large gathering, such as from the onsite input devices 216, the onsite mobile devices 212, the offsite participant devices 218, or any combination thereof. One purpose of the gathering presentation is to facilitate active engagement by making participants anticipate that their contributions to the expression of the whole would be highlighted on the gathering presentation. For example, a video feed may be selected from devices coupled to the experience engine system 304 to include in the gathering presentation. The selection may be based on loudness from the video feed, total movement from the video feed, other patterns from the video feed, choice of the producer crew, or any combination thereof.

The gathering presentation may be curated by a producer or the producer crew 206, such as someone operating the producer devices 318. The producer may curate sensory data streams from devices coupled to the experience engine system 304, such as audio streams or live video streams. The producer may also curate multimedia files received from the devices coupled to the experience engine system 304, including uploaded photographs, uploaded status updates, uploaded tweets, uploaded audio clips, or any combination thereof.

FIG. 8 shows an embodiment of a wireless device 800 which includes the capability for wireless communication. The wireless device 800 may be included in any one of the devices shown in FIG. 1 above, although alternative embodiments of those devices may include more or fewer components than the wireless device 800.

Wireless device 800 may include an antenna system 801. Wireless device 800 may also include a digital and/or analog radio frequency (RF) transceiver 802, coupled to the antenna system 801, to transmit and/or receive voice, digital data and/or media signals through antenna system 801.

Wireless device 800 may also include a digital processing system 803 to control the digital RF transceiver and to manage the voice, digital data and/or media signals. Digital processing system 803 may be a general purpose processing device, such as a microprocessor or controller for example. Digital processing system 803 may also be a special purpose processing device, such as an ASIC (application specific integrated circuit), FPGA (field-programmable gate array) or DSP (digital signal processor). Digital processing system 803 may also include other devices, as are known in the art, to interface with other components of wireless device 800. For example, digital processing system 803 may include analog-to-digital and digital-to-analog converters to interface with other components of wireless device 800. Digital processing system 803 may include a media processing system 809, which may also include a general purpose or special purpose processing device to manage media, such as files of audio data.

Wireless device 800 may also include a storage device 804, coupled to the digital processing system, to store data and/or operating programs for the wireless device 800. Storage device 804 may be, for example, any type of solid-state or magnetic memory device.

Wireless device 800 may also include one or more input devices 805, coupled to the digital processing system 803, to accept user inputs (e.g., telephone numbers, names, addresses, media selections, etc.) Input device 805 may be, for example, one or more of a keypad, a touchpad, a touch screen, a pointing device in combination with a display device or similar input device.

Wireless device 800 may also include at least one display device 806, coupled to the digital processing system 803, to display information such as messages, telephone call information, contact information, pictures, movies and/or titles or other indicators of media being selected via the input device 805. Display device 806 may be, for example, an LCD display device. In one embodiment, display device 806 and input device 805 may be integrated together in the same device (e.g., a touch screen LCD such as a multi-touch input panel which is integrated with a display device, such as an LCD display device). The display device 806 may include a backlight 806A to illuminate the display device 806 under certain circumstances. It will be appreciated that the wireless device 800 may include multiple displays.

Wireless device 800 may also include a battery 807 to supply operating power to components of the system including digital RF transceiver 802, digital processing system 803, storage device 804, input device 805, microphone 805A, audio transducer 808, media processing system 809, sensor(s) 810, and display device 806. Battery 807 may be, for example, a rechargeable or non-rechargeable lithium or nickel metal hydride battery. Wireless device 800 may also include audio transducers 808, which may include one or more speakers, and at least one microphone 805A. In certain embodiments of the present disclosure, the wireless device 800 may be used to implement at least some of the methods discussed in the present disclosure.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may thus be implemented using a variety of programming languages.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a tablet PC, a laptop computer, a set-top box (STB), a cellular telephone, an iPhone, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies or modules of the presently disclosed technique and innovation.

In general, the routines executed to implement the embodiments of the disclosure, may be implemented as part of an operating system or a specific application, component, program, object, module or sequence of instructions referred to as “programs.” The programs typically comprise one or more instructions set at various times in various memory and storage devices in a computer, and that, when read and executed by one or more processing units or processors in a computer, cause the computer to perform operations to execute elements involving the various aspects of the disclosure.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

While processes or blocks are presented in a given order, alternative embodiments may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein may be applied to other systems, not necessarily the system described above. The elements and acts of the various embodiments described above may be combined to provide further embodiments.

Any patents and applications and other references noted above, including any that may be listed in accompanying filing papers, are incorporated herein by reference. Aspects of the disclosure may be modified, if necessary, to employ the systems, functions, and concepts of the various references described above to provide yet further embodiments of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics and/or quotation marks. The use of highlighting has no influence on the scope and meaning of a term; the scope and meaning of a term is the same, in the same context, whether or not it is highlighted. It will be appreciated that same element may be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a program product comprising a computer-readable medium containing program code, which may be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a program stored in the computer. Such a program may be stored in a non transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non transitory, tangible computer readable storage medium and may include any embodiment of a program product or other data combination described herein.

The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A method to provide an emotional experience through a device for a person to participate in a large gathering of an event comprising:
facilitating the person to participate in an expression of a whole of the large gathering via the device;
presenting the expression of the whole on the device when an aggregate of individual contributions satisfy a threshold;
facilitating the person to join a small group of participants within the large gathering through the device;
providing an interface for intimate interaction within the small group, the interface providing a synchronized shared experience amongst members of the small group; and
presenting a version of a gathering presentation through the device, the gathering presentation featuring content related to or from a specific individual contributor or a specific small group of the large gathering.

2. The method of claim 1, wherein presenting the expression of the whole includes playing an audio synchronously coupled together with displaying a visual.

3. The method of claim 1, wherein presenting the expression of the whole includes streaming a live feed from a gathering location of the event, the live feed selected to focus on people participating in the expression of the whole at the gathering location.

4. The method of claim 1, wherein presenting the expression of the whole is triggered by a message from an experience engine system aggregating the individual contributions.

5. The method of claim 1, wherein presenting the expression of the whole scales as more of the individual contributions are aggregated without presenting actual statistic of people participating in the expression of the whole.

6. The method of claim 1, wherein presenting the expression of the whole includes presenting regions of people participating in the expression of the whole.

7. The method of claim 1, wherein providing the interface for intimate interaction includes opening up a communication channel with members of the small group.

8. The method of claim 1, wherein facilitating the person to join the small group includes displaying a suggestion to join the small group and receiving a confirmation to join the small group.

9. The method of claim 1, wherein providing the interface for intimate interaction includes making a group purchase on behalf of the small group through the interface.

10. The method of claim 1, wherein presenting the expression of the whole includes overtaking the interface for intimate interaction with the expression of the whole.

11. The method of claim 1, furthering comprising providing an expression interface to initiate a potential expression of the whole.

12. The method of claim 1, wherein facilitating the person to join the small group includes enabling the person to act as a group of one, wherein another participant or another small group is enabled to join or merge with the small group.

13. A method to provide an emotional experience for people connected via devices in a large gathering of an event through an experience engine system comprising:
aggregating individual contributions from individuals or small groups into an aggregate to participate in an expression of a whole of the large gathering;
generating the expression of the whole for broadcast when the aggregate of the individual contributions satisfy a threshold;
facilitating formation of a small group of participants within the large gathering;
providing a service to facilitate synchronized intimate interaction within the small group; and
generating a version of a gathering presentation configured to selectively focus attention of large subsets of participants of the large gathering on contents related to or from a specific individual contributor or a specific small group of the large gathering.

14. The method of claim 13, wherein generating the expression of the whole includes generating different visuals for multiple displays including a first display device offsite from a gathering location of the event and a second display device at the gathering location.

15. The method of claim 13, wherein aggregating the individual contributions includes detecting a pattern based on at least a sensor data stream from a sensor device at a gathering location of the event.

16. The method of claim 13, wherein aggregating the individual contributions includes aggregating virtual participation indications from participant devices offsite from a gathering location of the event.

17. The method of claim 13, wherein the expression of the whole is activity specific.

18. The method of claim 13, further comprising providing an expression generation interface to a device connected to experience engine system to orchestrate the expression of the whole.

19. The method of claim 13, wherein facilitating the formation of the small group includes forming the small group automatically based on geographical locations of members of the small group.

20. The method of claim 13, further comprising selecting a video feed from devices coupled the experience engine system to include in the gathering presentation based on loudness from the video feed.

21. The method of claim 13, further comprising receiving curation of sensory data streams from a producer device; wherein generating the gathering presentation includes presenting the curated sensory data streams in the gathering presentation.

22. The method of claim 13, further comprising receiving curation of multimedia files from a producer device; wherein generating the gathering presentation includes presenting the curated multimedia files in the gathering presentation.

23. The method of claim 13, wherein generating the gathering presentation is based on random selection of the contents related to or from the specific individual contributor or the specific small group.

24. The method of claim 13, wherein generating the gathering presentation is based on selection via popular votes by the participants of the contents related to or from the specific individual contributor or the specific small group.

25. The method of claim 13, further comprising generating a presence topology illustrating participants in relation to the whole of the large gathering and proximity relations of nearby participants and nearby small groups; wherein generating the expression of the whole includes generating the expression of the whole coupled to the presence topology as the expression is formed from one sector of the presence topology to another sector.

26. The method of claim 13, further comprising generating a presence topology illustrating participants in relation to the whole of the large gathering and proximity relations of nearby participants and nearby small groups; wherein facilitating formation of the small group includes facilitating movement of a participant between the nearby small groups.

27. An experience engine system providing an emotional experience for people connected via devices in a large gathering of an event comprising:
a processor;
a non-transitory storage medium including modules executable by the processor; the modules including:
an expression aggregation module when executed is configured to aggregate contributions into an aggregate from individuals or small groups to participate in an expression of a whole of the large gathering and to generate the expression of the whole for broadcast when the aggregate of the contributions satisfy a threshold;
a group facilitation module when executed is configured to facilitate formation of a small group of participants within the large gathering and provide a service to facilitate synchronized intimate interaction within the small group; and
a gathering management module when executed is configured to generate a version of a gathering presentation configured to selectively focus attention of participants of the large gathering on contents related to or from a specific individual contributor or a specific small group of the large gathering.

28. The system of claim 27, further comprising a presence topology module when executed is configured to generate a presence topology illustrating participants in relation to the whole of the large gathering and proximity relations of nearby participants and nearby small groups.
